(19) United States
(12) Patent Application Publication
(10) Pub. No.: US 2002/0045426 A1
(43) Pub. Date: Apr. 18, 2002

(54) Method of constructing a composite receiving band filter

(75) Inventors: Hiroshi Ogi, Tokyo (JP); Nobuyuki Gakuhari, Tokyo (JP)

Correspondence Address: Gary M. Anderson, Fulwider Patton Lee & Utecht, LLP, Suite 1550, 200 Oceangate, Long Beach, CA, 90802, US

(73) Assignee: VERTEX STANDARD CO., LTD.

(21) Appl. No.: 09/975,281

(22) Filed: Oct. 10, 2001

(30) Foreign Application Priority Data
Oct. 12, 2000 (JP) P2000-312538

(51) Int. Cl. H04B 1/44

(52) U.S. Cl. 455/78; 455/334

(57) ABSTRACT

In a radio transmission/receiving device in which the same communication frequency band is used for transmission and receiving modes, a low pass filter for preventing higher harmonics is arranged between an antenna and a transmission circuit under the transmission mode and a band filter for band selection is arranged between the antenna and a receiving circuit under the receiving mode, whereby a reduction of production costs of the system is achieved at by reducing the number of elements required for the band filter.

### BACKGROUND OF THE INVENTION

1. Field of the Invention

This invention relates to a method of constructing a composite receiving band filter in a radio transmission/receiving device, such as a transceiver, and wherein a low-pass filter for preventing a spurious discharge of higher harmonics (henceforth referred to as LPF) and a band filter for selecting a receiving frequency band (henceforth referred to as BPF) are provided, which relate to an improvement for reducing circuit elements composing the BPF.

2. Description of the Prior Art

Conventionally in a radio transmission/receiving device, such as a transceiver, as shown in FIG. 5, LPF 3 (selected corresponding to a communication frequency band selected out of 3a 3c) is inserted between an antenna 1 and a transmission circuit 2 under transmission mode, and a BPF 5 (selected corresponding to a communication frequency band selected out of 5a-5c) is inserted between the antenna 1 and a receiving circuit 4 under receiving mode.

Here, LPF 3 is inserted to prevent higher harmonics equivalent to integral times a basic frequency from being generated by the nonlinearity of an amplifier (generally a C-class amplifier with a high power efficiency is applied to) of a transmission circuit 2, and it's spurious discharged from the antenna 1 disturbing other communications.

Also, the BPF 5 is intended to previously remove receiving signals of unnecessary bands so as to input only a signal of a desired receiving frequency band out of signals received by the antenna 1 to the receiving circuit 4.

And, in the circuit composition of FIG. 5, based on an operation signal from an operation unit (not illustrated), a microcomputer circuit 6 switches each switch circuit 7, 8a-8c, 9a-9c, 10, 11 to form a selected connection status of a filter circuit corresponding to a settings and communication frequency band of the transmission/receiving mode.

In operation, when the transmission mode is set by the operation signal, the switch circuit 7 is connected to an s side, and when the receiving mode is set, the switch circuit 7 is connected to an r side, and by making the switch circuit 8a-8c, 9a-9c, 10, 11 a selected status of either a, b or c according to a communication frequency band selected and set under the transmission/receiving mode, one of the three LPFs 3a, 3b and 3c provided between each switch circuit 8a-8c and 9a-9c is selected, and one of the three BPFs 5a, 5b and 5c provided between switch circuits 10 and 11 is also selected.

Incidentally, the switch circuit 10, 11 is composed by a three-point switching method and the switch circuit 8a-8c, 9a-9c is individually designed by a two-point switching method, because a relay switch circuit is applied to since an electric power is large in a transmission circuit part.

Naturally, each LPF 3a, 3b, 3c has a cut-off frequency to remove signals with frequencies equivalent to integral times the selected and set communication frequency band under transmission mode, and each BPF 5a, 5b, 5c has both cut-off frequencies passing only signals of the selected and set communication frequency band.

Accordingly, the cut-off frequency of LPF 3a, 3b, 3c is not always needed to be set for an upper limit frequency band and a frequency below twice a lower limit frequency of the communication frequency band is enough.

### SUMMARY OF THE INVENTION

In the subject invention utilizing an LPF 3a, 3b, 3c for preventing a spurious discharge of higher harmonics, a circuit composition by which normally a filter degree between 5th to 7th degree can be obtained is applied so as to obtain a prescribed flat characteristic and cut-off characteristic respectively in a passing band and a changing band, and supposing a 5th-degree simultaneous Chebychev type LPF, for example, at least seven elements (capacity C₁₁-C₁₅ and inductance L₁₁, L₁₂) are required as shown in FIG. 6, and as a strict frequency characteristic is required even in case of BPF 5a, 5b, 5c for receiving band selection, normally a filter composition of 5th degree or so is employed, but supposing a 5th-degree Butterworth type BPF, for example, at least ten elements (capacity C₂₁-C₂₅, inductance L₂₁-L₂₅) are required as shown in FIG. 7.

Accordingly, in the part composing the circuit of FIG. 5 in the radio transmission/receiving device, together with each switch 7, 8a-8c, 9a-9c, 10 and 11 there are many component parts, preventing a reduction of product costs.

Especially, as the number of parts becomes extreme when the filter degree is raised to obtain a favorable flat characteristic and steep cut-off characteristic about BPF 5a, 5b, 5c, a simplification of the circuit composition is required for the part.

Thus, in consideration of the above problem, the subject invention is made with an object of reducing the number of parts required for a BPF and thereby reducing production costs of the radio transmission/receiving device.

This invention relates to a method of constructing a composite receiving BPF in a radio transmission/receiving device in which the same communication frequency band is used for transmission and receiving modes, an LPF for preventing a discharge of higher harmonics is arranged between an antenna and a transmission circuit under the transmission mode, and a BPF corresponding to said communication frequency band is arranged between the antenna and a receiving circuit under the receiving mode, wherein: the LPF setting a cut-off frequency for an upper limit frequency of said communication frequency band is connected to said antenna; a high-pass filter (henceforth referred to as HPF) setting a cut-off frequency for a lower limit frequency of said communication frequency band is connected to a signal input terminal of said receiving circuit; a switch circuit for connecting said LPF to a signal output terminal of said transmission circuit under the transmission mode and connecting said LPF to said HPF under receiving mode is provided; and a BPF comprising a serial circuit of said LPF and said HPF is composed under the receiving mode.

Also, for the radio transmission/receiving device, there are many models that perform transmission and receiving by selecting one band from a plurality of communication frequency bands, and in such a case, a composite receiving band filter in a radio transmission/receiving device can be applied to, wherein: a first switch circuit for connecting only an LPF corresponding to the selected communication frequency band to said antenna is provided between each LPF setting a cut-off frequency for an upper limit frequency of said each communication frequency band and said antenna; a second switch circuit for connecting only an HPF corresponding to the selected communication frequency band to a signal input terminal of said receiving circuit is provided between each HPF setting a cut-off frequency for a lower limit frequency of said each communication frequency band and said receiving circuit; and a third switch circuit for connecting said LPF to said transmission circuit under the transmission mode and connecting each LPF to each HPF under receiving mode is provided between said each LPF and said each HPF of which communication frequency bands mutually correspond.

In the subject invention, to use the LPF used for removing higher harmonics under transmission mode also under the receiving mode, the BPF corresponding to the receiving frequency band is composed of a serial circuit of said LPF and the HPF provided specially for receiving.

As the communication frequency band is the same under the transmission mode and the receiving mode, the cut-off frequency of the LPF needs to be set for the upper limit of the communication frequency band, but as described above, since a function of the LPF under transmission mode is to remove higher harmonics and a frequency equal to or below integral times the lower limit of the communication frequency band is enough, there is no inconvenience even when the cut-off frequency is set as above.

And, rather than constructing a BPF dedicated for receiving separately, constructing a BPF with a serial circuit using the LPF for the transmission mode for cutting off the upper limit makes the number of elements far less, and since the switch circuit 7 inserted between the antenna 1 and the filter circuit in FIG. 5 is not necessary, the number of parts can be reduced considerably.

### BRIEF DESCRIPTION OF THE DRAWINGS

FIG. 1 is a system circuit diagram of a filter circuit part arranged between an antenna and transmission/receiving circuits in a transceiver related to the embodiment of the invention.

FIG. 2 is an electric circuit diagram of a ladder type HPF.

FIG. 3 is an electric circuit diagram of a BPF formed by serially connecting a 5th-degree simultaneous Chebychev type LPF and a ladder type HPF.

FIG. 4 is a frequency characteristic diagram of a BPF formed with an LPF and an HPF and their serial circuit.

FIG. 5 is a system circuit diagram of a filter circuit part arranged between an antenna and transmission/receiving circuits in a radio transmission/receiving device related to the conventional technology.

FIG. 6 is an electric circuit diagram of the 5th-degree simultaneous Chebychev type LPF.

FIG. 7 is an electric circuit diagram of a 5th-degree Butterworth type BPF.

### DETAILED DESCRIPTION OF THE PREFERRED EMBODIMENTS

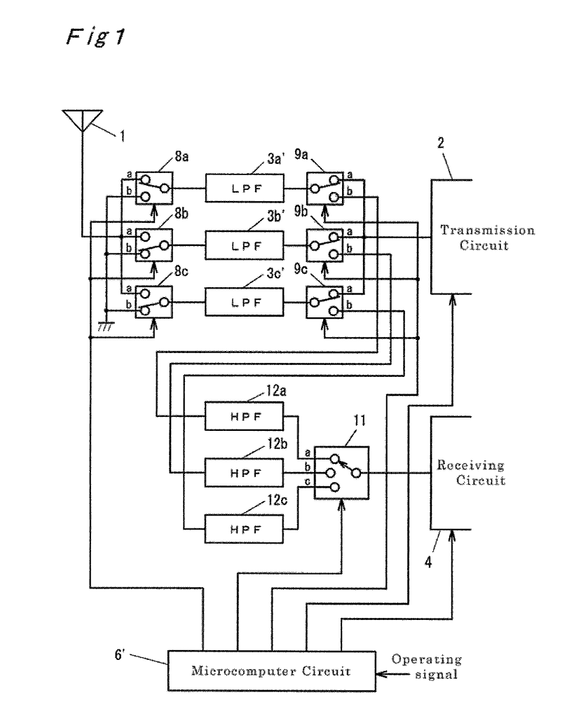

Henceforth preferred embodiments of the method of constructing a composite receiving BPF in the radio transmission/receiving device of this invention are described using FIG. 1 through FIG. 4.

First, FIG. 1 shows a filter circuit part arranged between an antenna and transmission/receiving circuits, and like FIG. 5, it is a part composing an LPF for preventing a spurious discharge of higher harmonics under the transmission mode and a BPF for selecting a desired receiving band.

Also, the components of circuit elements of FIG. 1 that are given the same symbols as in FIG. 5 correspond to the same circuit elements.

Here, the circuit composition of this embodiment features the following:

(1) In the circuit composition of FIG. 5, the switch circuit 7 that is switched by the transmission mode/receiving mode is provided between the antenna 1 and the switch circuit 8 for selection related to the LPF 3a-3c, and between the antenna 1 and the switch circuit 10 for selection related to the BPF 5a-5c, while in this embodiment, there is not an element that corresponds to the switch circuit 7 and the antenna 1 is connected directly to the switch circuit 8a-8c for selection related to the LPF 3a′-3c′.

(2) In the circuit composition of FIG. 5, the filter selected by the switch circuit 10, 11 is the BPF 5a-5c dedicated for receiving, while in this embodiment, an HPF 12a-12c, not a BPF, is provided.

(3) In the circuit composition of FIG. 5, transmission filter circuits (8a-8c, 3a-3c, 9a-9c) and receiving filter circuits (10, 5a-5c, 11) are applied to by being completely switched by the switch circuit 7, and by switching switch circuits (8a-8c, 9a -9c), (10, 11) and selecting the LPF 3a-3c and the BPF 5a-5c by the selected communication frequency band, and these are connected respectively to the transmission circuit 2 and the receiving circuit 4, while in this embodiment, a connection status of the LPF 3a′-3c′ and the transmission circuit 2 or the LPF 3a′-3c′ and the HPF 12a-12c is composed by switching the switch circuit 9a-9c under transmission/receiving mode. Also, the switch circuit 9a-9c of FIG. 5 is controlled to a switching status same as the connection status of the switch circuit 8a-8c based on the selected communication frequency band, while in this embodiment, it is simply switched corresponding to the transmission/receiving mode.

In the circuit described above, when the transmission mode is set from the operation unit (not illustrated), the microcomputer circuit 6′ makes the switch circuit 9a-9c the connection status of the a side and connects the LPF 3a′-3c′ to the transmission circuit 2.

Accordingly, an output signal of the transmission circuit 2 is outputted to the antenna 1 through the LPF 3′ selected by the switch circuit 8a-8c according to the set communication frequency band and can be discharged from the antenna 1 after removing higher harmonics contained in said output signal.

Also, under this condition, receiving circuits 12a-12c, 11, 14 are separated completely from transmission circuits 8a-8c, 3a-3c, 9a-9c, 2 by the switch circuit 9a-9c.

Incidentally, FIG. 1 shows a condition in which the LPF 3a′ is selected.

On the other hand, when the receiving mode is set from the operation unit, the microcomputer circuit 6′ makes the switch circuit 9a-9c the connection status of the b side and connects the LPF 3a′-3c′ to the HPF 12a-12c by separating from the transmission circuit 2.

In this case, a connection circuit as (antenna 1)→?(switch circuit 8)→?[LPF 3′ selected by switch circuit 8 according to the set communication frequency band]→?(switch circuit 9)→?[HPF 12 selected by switch circuit 11 according to the set communication frequency band]→? (switch circuit 11)→? (receiving circuit 4) is composed, namely a serial circuit of the LPF 3′ and HPF 12 is arranged between the antenna 1 and the receiving circuit 4.

Meantime, supposing a transmission frequency range and a receiving frequency range of a transceiver related to this embodiment as (1) 50.00-54.00 MHz, (2) 144.00-146.00 MHz and (3) 430.00-440.00 MHz, for example, the LPF 3a′ and the HPF 12a are selected according to band (1), the LPF 3b′ and the HPF 12b are selected according to band (2) and the LPF 3c′ and the HPF 12c are selected according to band (3), and each cut-off frequency f_{C1}, f_{C2} of the LPF 3a′-3c′ and the HPF 12a-12c is set as follows:

(1) f_{C1} of LPF 3a′=54.00 MHz, f_{C2} of HPF 12a=50.00 MHz

(2) f_{C1} of LPF 3b′=146.00 MHz, f_{C2} of HPF 12b=144.00 MHz

(3) f_{C1} of LPF 3c′=440.00 MHz, f_{C2} of HPF 12c=430.00 MHz

Incidentally, the cut-off frequency of the LPF 3a-3c does not always need to be set for the upper limit of each communication frequency band and a setting for a value that can remove higher harmonics is enough, and as described above, the LPF 3a′-3c′ of this embodiment is set for the upper limit of each communication frequency band.

Accordingly, when the serial circuit of the LPF 3 and HPF 12 is composed using the LPF 3a′-3c′ used under the transmission mode also under the receiving mode as above, a BPF corresponding to each band (1)-(3), like the BPF 5a-5c dedicated for the receiving mode in the circuit of FIG. 5, can be composed.

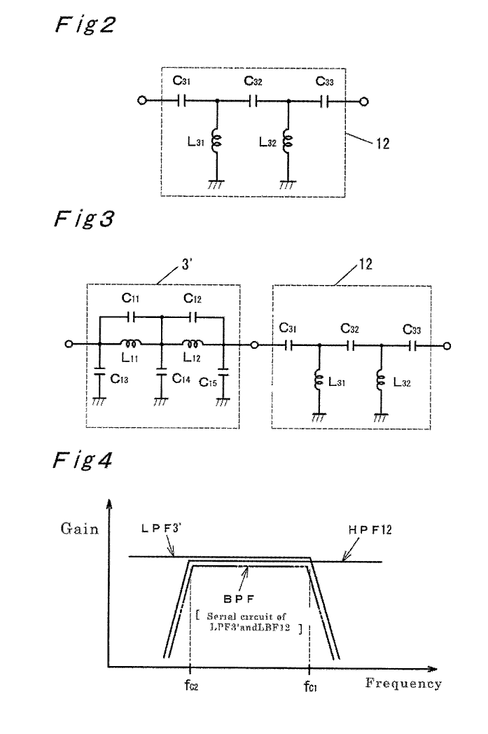

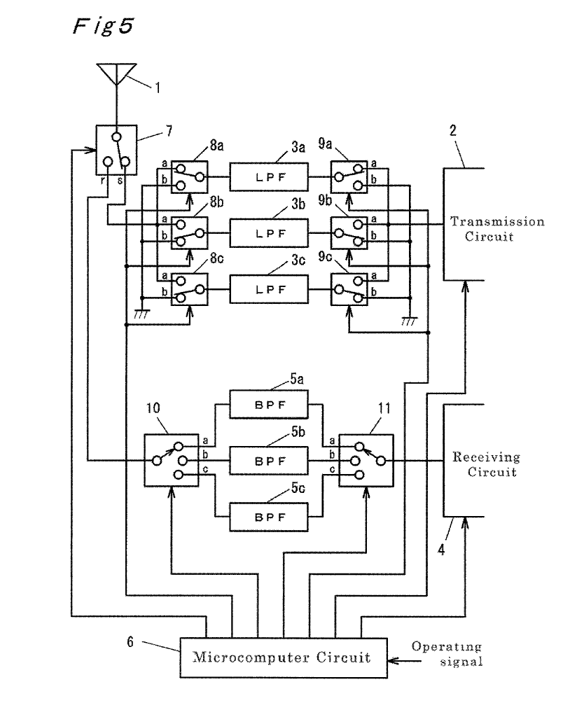

In concrete, supposing that a ladder type HPF as shown in FIG. 2 is applied to as the HPF 12 and a 5th-degree simultaneous Chebychev type LPF is applied to the LPF 3, like the circuit of FIG. 5, said serial circuit under the receiving mode is the circuit shown in FIG. 3 and a BPF with a frequency characteristic as shown in FIG. 4 can be composed corresponding to each band (1)-(3).

As a result, under the receiving mode, using the LPF 3 used under the transmission mode, a receiving signal can be inputted to the receiving circuit 4 by way of the BPF composed of the serial circuit with the HPF 12, and like a transceiver by the circuit composition of FIG. 5, a desired receiving band can be selected.

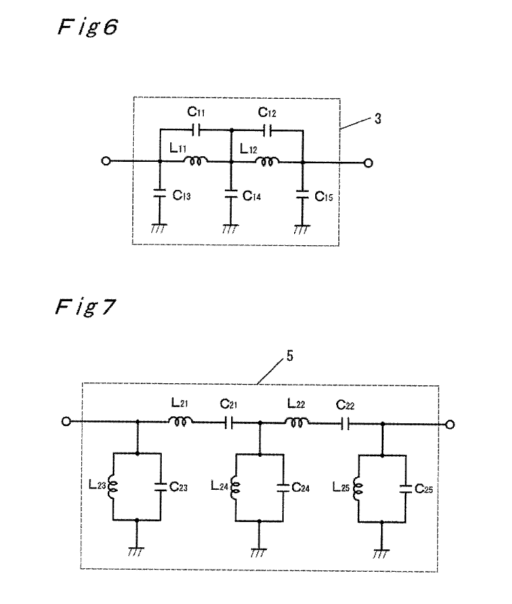

And, when the circuit of BPF 5 (FIG. 7) provided specially for the receiving mode in FIG. 5 and the circuit of HPF 12 of FIG. 2 are compared, the BPF 5 is a 10-element circuit formed with capacities C₂₁-C₂₅ and inductances L₂₁₋₂₅, while the HPF12 is a 5-element circuit formed with capacities C₃₁-C₃₃ and inductances L₃₁, L_{32.}

That is, by composing a BPF with a serial circuit with the HPF 12 by using the LPF 3a 3c in the receiving mode, too, the number of elements can be reduced by five with regard to individual band, and as a whole (all of band (1)-(3)), fifteen elements can be reduced.

Also, since the switch circuit 7 for switching between transmission and receiving systems and the switch circuit 10 for selecting the BPF 5a-5c that are required in the circuit composition of FIG. 5 are not necessary, the number of parts can be reduced, and along with a simplification of circuit composition, a size reduction as well as a reduction of the number of assembly processes can also be gained.

Incidentally, in the above embodiment, a model that performs transmission/receiving by selecting one band from a plurality of communication frequency bands is described, however, when transmission/receiving is done with only a single communication frequency band, naturally only one each of LPF 3′ and HPF 12 are enough, switch circuits 8a-8c, 11 for band selection are not necessary, and only one switch circuit 9 is enough.

The composition method of receiving BPF in the radio transmission/receiving device of the invention having the above-mentioned composition takes the following effects:

Thus the subject invention allows for the construction of a radio transmission/receiving device, wherein the same communication frequency used for transmission and receiving modes, an LPF for preventing a discharge of higher harmonics is arranged between an antenna and a transmission circuit under the transmission mode, and a BPF corresponding to said communication frequency band is arranged between the antenna and a receiving circuit under the receiving mode, and, by setting a cut-off frequency of said LPF for an upper limit of the communication frequency band so as to compose a BPF with a serial circuit with an HPF having a cut-off frequency set for a lower limit of the communication frequency band by using the LPF under the receiving mode, too, the number of parts necessary for the BPF can be reduced considerably, and eventually a reduction of production costs the radio transmission/receiving device can be made possible.

The subject invention also allows for a radio transmission/receiving device that performs transmission/receiving by selecting one band from a plurality of communication frequency bands, wherein, the number of switch circuits can be reduced considerably, and by a further reduction of the number of parts and a simplification of circuit composition, a size reduction of the device as well as a reduction of the number of assembly processes can also be realized.

What is claimed is:

1. A method of constructing a composite receiving band filter in a radio transmission/receiving device in which the same communication frequency band is used for transmission and receiving modes, a low-pass filter for preventing a discharge of higher harmonics is arranged between an antenna and a transmission circuit under the transmission mode, and a band filter corresponding to said communication frequency band is arranged between the antenna and the receiving circuit under the receiving mode, wherein:
the low-pass filter setting a cut-off frequency for an upper limit frequency of said communication frequency band is connected to said antenna; a high-pass filter setting a cut-off frequency for a lower limit frequency of said communication frequency band is connected to a signal input terminal of said receiving circuit; a switch circuit for connecting said low-pass filter to a signal output terminal of said transmission circuit under the transmission mode and connecting said low-pass filter to said high-pass filter under receiving mode is provided; and
a band filter comprising a serial circuit of said low-pass filter and said high-pass filter is composed under the receiving mode.

2. A method of constructing a composite receiving band filter in a radio transmission/receiving device in which one band is selected from a plurality of communication frequency bands under transmission and receiving modes, a low-pass filter for preventing a discharge of higher harmonics is arranged between an antenna and a transmission circuit under the transmission mode, and a band filter corresponding to the selected communication frequency band is arranged between the antenna and a receiving circuit under the receiving mode, wherein:
a first switch circuit for connecting only a low-pass filter corresponding to the selected communication frequency band to said antenna is provided between each low-pass filter setting a cut-off frequency for an upper limit frequency of said each communication frequency band and said antenna;
a second switch circuit for connecting only a high-pass filter corresponding to the selected communication frequency band to a signal input terminal of said receiving circuit is provided between each high-pass filter setting a cut-off frequency for a lower limit frequency of said each communication frequency band and said receiving circuit; and
a third switch circuit for connecting said low-pass filter to said transmission circuit under the transmission mode and connecting each low-pass filter to each high-pass filter under receiving mode is provided between said each low-pass filter and said each high-pass filter of which communication frequency bands mutually correspond.
